(19) United States
(12) Patent Application Publication
(10) Pub. No.: US 2026/0085730 A1
(43) Pub. Date: Mar. 26, 2026

(54) Disc Brake, Use of the Disc Brake, and Method for Engaging the Disc Brake

(71) Applicant: KNORR-BREMSE Systeme fuer Nutzfahrzeuge GmbH, Muenchen (DE)

(72) Inventors: Alexander WERTH, Muenchen (DE); Abdelaziz RGUICHI, Olching (DE); Erkan AKBALIK, Muenchen (DE); Michael PESCHEL, Schoengeising (DE); Ralf WEBER, Muenchen (DE)

(21) Appl. No.: 19/112,633

(22) PCT Filed: Sep. 1, 2023
(86) PCT No.: PCT/EP2023/074042

§ 371 Date: Mar. 18, 2025

(30) Foreign Application Priority Data
Sep. 19, 2022 (DE) 10 2022 123 994.2

(51) Int. Cl. F16D 55/226; F16D 65/18; F16D 121/04; F16D 125/64

(52) U.S. Cl. CPC F16D 55/226; F16D 65/183; F16D 2121/04; F16D 2125/64

(57) ABSTRACT

A disc brake for a motor vehicle and/or bus with an electric generator brake includes a brake disc with an axis of rotation and a set of brake pads for engaging the brake disc. The disc brake has a brake caliper designed as a sliding caliper. The disc brake has an engagement device for actuating the brake pads, which is arranged in a mounting space of a brake caliper. The disc brake also has an actuating element for introducing force into the engagement device with an actuating force. The engagement device has a brake lever on which the actuating element acts with the actuating force, wherein the engagement device acts on the brake pads with an engagement force along an engagement axis. The length of the brake lever is selected such that the transmission ratio between actuating force and engagement force is between 1:15.60-1:16.45, preferably with a bridge stroke of 2.5-4 mm.

### BACKGROUND AND SUMMARY

The present invention relates to a disc brake for a motor vehicle and/or bus with an electric generator brake, as well as to a use of the disc brake in a motor vehicle and/or bus with an electric generator brake, and to a method for engaging the disc brake.

Disc brakes have design compromises at various points in order to achieve a certain engagement force. For example, due to the limited space available for the overall design of a disc brake in a vehicle, brake levers are designed in such a way that they can exert an engaging effect while pivoting at a large pivoting angle and forming so-called progressive lines of force, even at high speeds.

Due to cooperative braking behavior, e.g., in electrically powered vehicles, lower forces can act on the disc brakes, so that these compromises can be eliminated in favor of an optimized and compact design.

The object of the present invention is therefore to adapt the design of the disc brake to the requirements of electrically powered motor vehicles or buses.

The invention achieves this object by means of the subject matter of the independent claim(s).

A disc brake according to the invention is intended for use in a motor vehicle and/or bus with an electric generator brake. It comprises a brake disc with an axis of rotation and a set of brake pads for clamping the brake disc. It also has a brake caliper designed as a sliding caliper. It also has an engagement device for actuating the brake pads, which is arranged in a brake caliper mounting space.

The disc brake also has an actuating element for introducing force into the engagement device with an actuating force. This can preferably be a brake cylinder, in particular a pneumatic brake cylinder.

The engagement device also has a brake lever on which the actuating element acts with the actuating force. The engagement device acts on the brake pads with an engagement force along an engagement axis.

In accordance with the invention, the length of the brake lever is selected such that the transmission ratio between the actuating force and the engagement force is between 1:15.60-1:16.45. This transmission ratio is particularly preferred for a bridge stroke of 2.5-4 mm.

This transmission ratio is higher than in conventional disc brakes of the same type and has the advantage that individual parts can be made smaller, in particular the actuating element or the brake cylinder. The installation space gained as a result, particularly in the axial direction, can be used to increase the size of batteries or the like.

Advantageous embodiments of the disc brake are the subject of the dependent claims.

Furthermore, the brake lever can have a spherical cap for receiving an actuating piston of the actuating element and can also have a curved rolling surface along which the brake lever rolls on a rolling bearing in the brake caliper's mounting space. The distance between the center of the curvature of the spherical cap of the brake lever and the center of the curvature of the rolling surface of the brake lever is between 78-82 mm. A brake lever enlarged in this way makes it possible to reduce or completely avoid the occurrence of progressive lines of force during the development of force during the braking process, which has particular advantages for ABS systems.

The engagement device has the aforementioned rolling bearing for pivotably mounting the brake lever, wherein the brake lever and/or the rolling bearing has means for limiting the pivot angle, wherein the means are arranged such that the pivot angle is limited to less than 90°, preferably less than 88°. Corresponding means can be taken from EP 2 896 851 B1, for example. This has the advantage that the height of the mounting space can be reduced. The installation space thus gained can be used to improve stability by thickening the walls.

In a preferred variant, the brake caliper can have an installation opening which has caliper struts with an axial extension on the edge, wherein the caliper struts have a radial thickness of more than 13 mm, preferably 14-17 mm, particularly preferably 15.5 mm +/−1 mm. These radial thicknesses enable better caliper stability and lower mechanical elasticity of the entire system.

The brake caliper can also have a caliper back, wherein no further element spanning the installation opening in the axial direction protrudes radially from the caliper back. This also allows installation space to be gained or miniaturization to be achieved.

The disc brake can have a brake carrier with pad shafts, wherein pad shafts have guide pockets on the edge for holding and guiding brake pads. This means that there is no need to provide a bracket at the installation opening, which also benefits the compact design.

The guide pockets are advantageously formed by projections that protrude into the pad shaft on the edge opposite a pad shaft wall. At higher lateral forces, there is a risk of deformation of these projections. However, such high lateral forces are prevented from the outset by the cooperative braking of electrically powered vehicles.

Further advantages result from lowering the disc brake in relation to the brake disc axle by 8.5 mm, which makes it possible to make the installation space available through the lever and increase the transmission ratio while simultaneously reducing the actuation travel of the cylinder.

An additional improvement is achieved by the fact that the flange for the actuator can now be located within the rim contour, thus reducing the installation space required for the disc brake with actuator in the axial direction. This makes space available on the axle of the vehicle that can be used by the drive or batteries.

An additional further reduction in the space required by the disc brake is achieved by arranging the engagement axis at a distance X parallel to the axis of rotation, wherein the ratio of the distance X to the radial thickness of the caliper struts is between 2.5-8.5 mm The use of the disc brake according to the invention in a motor vehicle and/or bus with an electric generator brake, which performs cooperative braking at the same time as the disc brake, is also in accordance with the invention.

Also according to the invention is a method for engaging a disc brake according to the invention, wherein the brake lever is pivoted at a pivot angle of less than 90°, preferably less than 88°, during the engagement process over the entire service life of the brake.

In the following, the invention is described in greater detail with reference to the drawing by means of exemplary embodiments, wherein further advantageous variants and embodiments are also discussed. It should be emphasized that the exemplary embodiments discussed below are not intended to describe the invention exhaustively, but that variants and equivalents not shown are also feasible and fall within the scope of the claims.

### BRIEF DESCRIPTION OF THE DRAWINGS

FIG. 1 is a perspective view of a disc brake according to an embodiment of the invention;

FIG. 2 is a side view of the disc brake of FIG. 1;

FIG. 3 is a sectional view of the disc brake of FIGS. 1 and 2;

FIG. 4 is a detailed view of FIG. 3;

FIG. 5 is a perspective view of the brake carrier of the disc brake;

FIG. 6 is a further perspective view of the brake carrier of FIG. 5 with inserted brake pads; and

FIG. 7 is another perspective view of FIGS. 5 and 6 from a different direction with brake pads fitted; and

FIG. 8 shows installation of the disc brake within the rim contour

### DETAILED DESCRIPTION OF THE DRAWINGS

The present invention relates to a disc brake for motor vehicles and buses which use electric generator brakes and in which an electric motor in generator mode generates electrical energy during braking. The disc brake itself according to the invention can be actuated in the classical manner, e.g., as a pneumatic brake or another type of actuation.

The aforementioned vehicles are thus braked cooperatively. The disc brake according to the invention is adapted to the operation of cooperative braking.

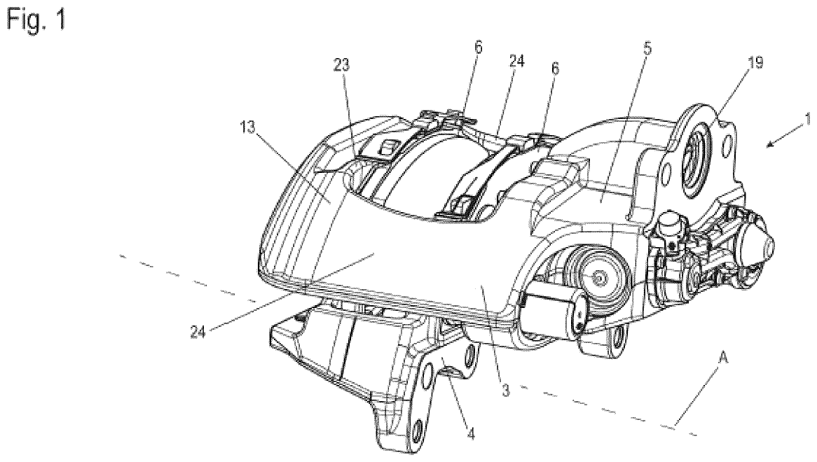

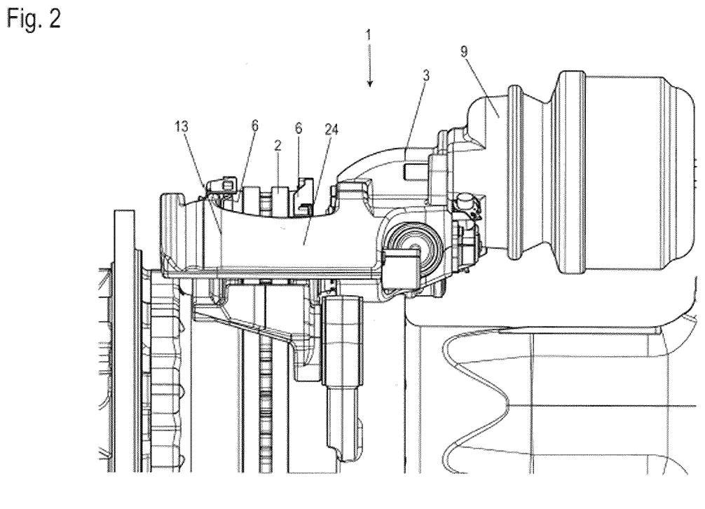

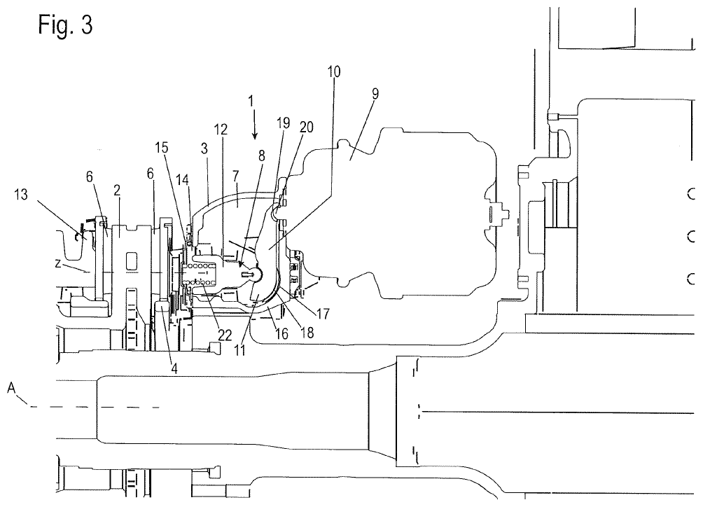

According to FIGS. 1-4, the disc brake 1 has a brake disc 2 with an axis of rotation A, which is used as a reference axis for defining a radial direction.

The brake disc 2 is spanned by a brake caliper 3. This is typically made of cast iron and can be formed in one piece or from multi-part bolted components. However, the one-piece design of the brake caliper 3 is preferred. The brake caliper is preferably designed as a sliding caliper and is attached to a vehicle-side brake carrier 4 so that it can be axially displaced parallel to the axis of rotation A.

The brake carrier 4 has two pad shafts for the arrangement of two brake pads 6. The brake pads 6 are in frictional contact with both sides of the brake disc 2 during braking.

The brake caliper 3 has a mounting chamber 7 in which an engagement device 8 is positioned, with a brake lever 10 that can be actuated via a brake cylinder 9, which brake lever is designed as an eccentric 11 at the end and rests against a bridge 12 in which adjusting spindles 22 are mounted, via which the associated brake pad 6 can be pressed against the brake disc 2. The longitudinal axis of the adjusting spindles 22 defines an engagement axis Z. An actuating piston 20 of the brake cylinder 9 lies in a spherical cap 19 of the brake lever 10. The brake caliper 3 is displaced in such a way that the opposite, reaction-side brake pad 6 is pressed against the other side of the brake disc 2, wherein this reaction-side brake pad 6 rests against a caliper back 13 of the brake caliper 3.

For mounting the functional parts located in the mounting chamber 7, a mounting opening 14 is provided on the side facing the action-side brake pad 4 and is closed by a closure plate 15, wherein the two aforementioned adjusting spindles pass through this closure plate 15.

In the exemplary embodiment, the eccentric 11 is supported on the side opposite the bridge 12 on a caliper head 16 of the brake caliper 1, in areas that are formed in a semicircle over an angular range of approximately 180° as support surfaces 17. Rolling bearings 18 are arranged between the support surfaces 17 and the eccentric 11 to allow the brake lever 6 to pivot easily. The design-related displaceability of this bridge 12 within the brake 1, in particular in relation to the brake carrier 4, is preferably 2.5-4 mm.

According to the present invention, due to the cooperative braking at higher speeds, a reduced force can be applied for the initial braking. As a result, the design of the disc brake can be changed in favor of a smaller dimensioning.

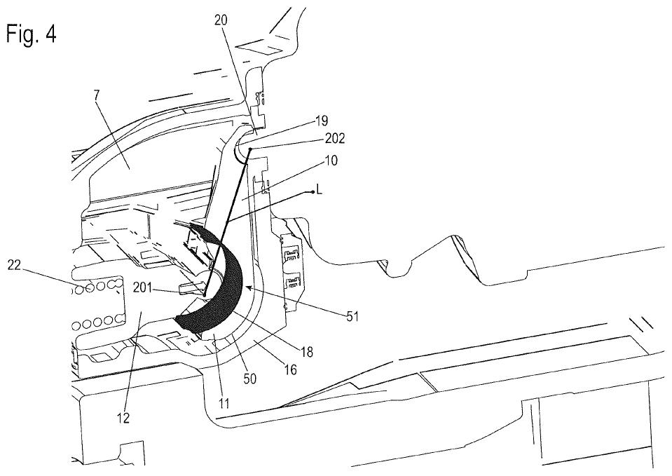

The present invention is based on the idea of bringing the point of application of the brake lever 10 for clamping the brake pads 6 and thus the engagement axis Z closer to the axis of rotation A. This allows the brake lever 10 to be longer overall. The length L of the brake lever 10 can be between 78-82 mm in relation to the center 202 of the curvature of the calotte 19 and to the center 201 of the curvature of the rolling surface 50 along which the brake lever 10 rolls on the rolling bearing 12. This is particularly emphasized in FIG. 4. The pivot path 51 corresponding to the rolling surface 50 is highlighted and has been emphasized from the plane of the drawing sheet. Such a long brake lever is not yet known for brakes.

The extended lever reduces the necessary actuating force. Accordingly, the length or dimension of the brake cylinder 9 and/or another actuating element of the disc brake can be significantly reduced. This creates additional installation space in the axial direction within a vehicle for the arrangement of electric batteries or the like.

At the same time, the transmission ratio of the actuating force to be applied by the brake cylinder 9 to the engagement force exerted on the brake pads changes to a range between 1:15.60-1:16.45. This transmission ratio makes it possible to reduce the pivot angle and thus also the space required by the brake lever 10 for the pivot movement. If the distance between the brake lever and the brake pads is known, the optimum length of the brake lever can be calculated by trigonometric calculation from the aforementioned transmission ratio.

The pivot movement of the brake lever is divided into the so-called idle stroke, the actuation stroke and the stroke reserve.

The idle stroke is the stroke required to bridge the clearance of the brake pads. A very low force is required to overcome this. This is followed by the actuation stroke for engaging the brake and a stroke reserve, which is maintained due to wear and to maintain the required engagement force. The stroke reserve is measured by the elasticity of the engagement device 8, i.e., the extent to which the engagement device 8 yields elastically during actuation. Due to the repositioning of the point of application of the brake lever and thus the engagement axis Z, the elasticity of the engagement device 8 decreases.

Due to the lower elasticity of the engagement device, the stroke reserve to be maintained can be reduced, which reduces the angular coverage of the brake lever 10 to a pivot angle of the brake lever 10 to less than 90°, preferably less than 88°. In other words, the pivot lever only needs to be pivoted to a lesser extent than in the known prior art. This reduced pivoting additionally reduces the spatial requirement for the space to be provided.

This additional space allows the brake caliper to be redesigned. The brake caliper has a lower opening to accommodate and engage over the brake disc 2, which is typical for the design of a caliper. In addition, the back of the brake caliper has an installation opening 23 for mounting the brake pads 6 in the brake carrier 4.

Caliper struts 24 are arranged on both sides of the installation opening 23 and extend perpendicular to the plate plane of the brake disc 2. The radial thickness of these caliper struts 24 is preferably more than 13 mm, preferably 14-17 mm, in particular 15.5 mm +/−1 mm. Caliper struts of this thickness are not yet known and are made possible by the additional space gained by repositioning the engagement axis Z and the components required for clamping in the direction of the axis of rotation.

Due to the improved trigonometry of the arrangement and redesign of the brake lever 10 and the associated changed transmission ratio and the increased mechanical rigidity of the engagement device 8, so-called progressive force lines can also be reduced during power transmission, which has advantages when using this disc brake in a vehicle with ABS brake systems, among other things. Overall, the application of force by the brake cylinder 9 on the brake lever 10 of the disc brake according to the invention is more uniform.

It should also be mentioned that the thickness of the brake pads and/or the brake disc and the brake disc diameter can also be reduced due to the increased mechanical rigidity of the engagement device 8. Furthermore, as previously discussed, the installation dimension of the brake is reduced.

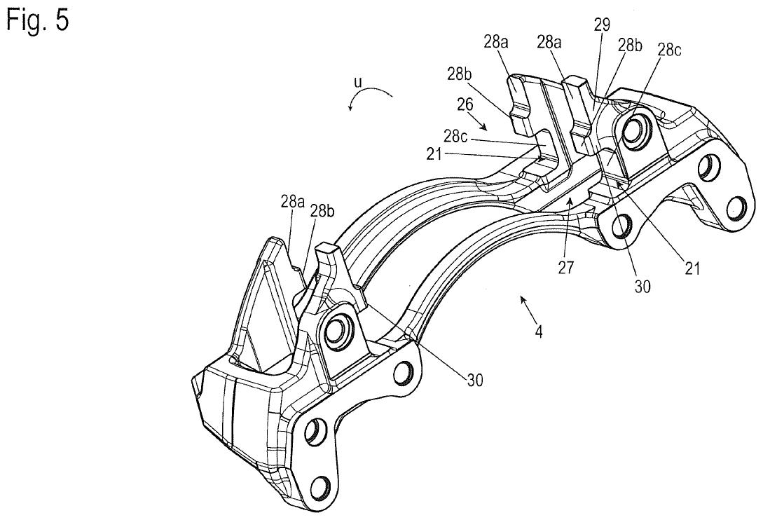

In the radial direction, no further element, in particular no pad retaining bracket, protrudes radially from the back of the caliper at the height of the installation opening 24. In this variant, the brake pads are secured by the brake carrier 4, as explained on the basis of FIG. 5.

FIG. 5 shows a brake carrier 4 for use in the disc brake of FIGS. 1-3 with corresponding pad shafts 26, 27. The pad shafts 26, 27 are each bounded laterally in the direction of rotation U and against the direction of rotation U by edge-side support surfaces 28a, 28b, 28c on brake carrier horns 29. The pad shafts 26, 27 have guide pockets 21 below the support surfaces 28a, in which the brake pads are inserted via edge-side projections, possibly with the aid of retaining springs. The guide pockets 21 are formed by a projection 30 projecting into the shaft, which in turn has an end support surface 28b. The outer contour of the brake pads substantially corresponds to the outer contour of the pad shaft.

An edge-side free surface 28c is arranged between the support surfaces 28a and 28b. The edge-side free surface 28b of the projection 30 is rectangular in shape, with the special feature that the extension of the free surface 28b in the axial direction in relation to the axis of rotation A is greater than the extension of the support surface in the radial direction. Normally, an attempt would be made at this point to distribute the force as evenly as possible over a large area with high applied forces.

However, this is not necessary in the present case because the cooperative braking means that a lower proportion of force acts on the support surfaces, particularly when braking at high speeds, and deformation tendencies occur to a lesser extent as a result. In contrast, this form of mounting is advantageous in terms of saving space for the overall height of the brake and at the same time enables a comparatively filigree design of the brake carrier 4 with reduced spatial requirements and dead weight.

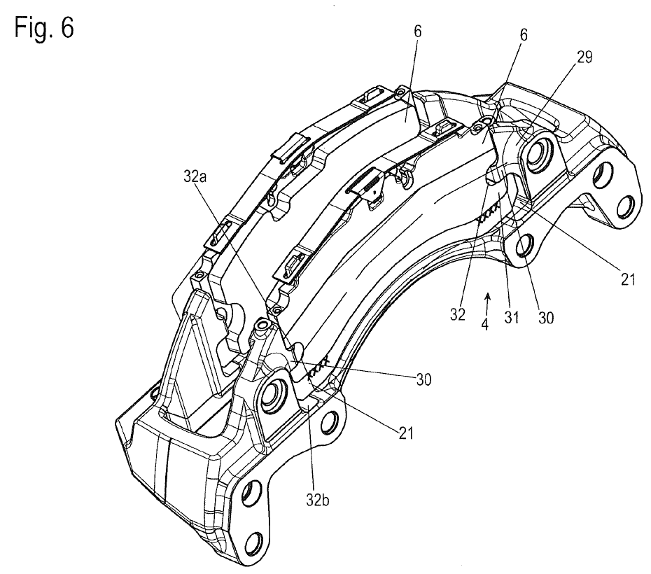

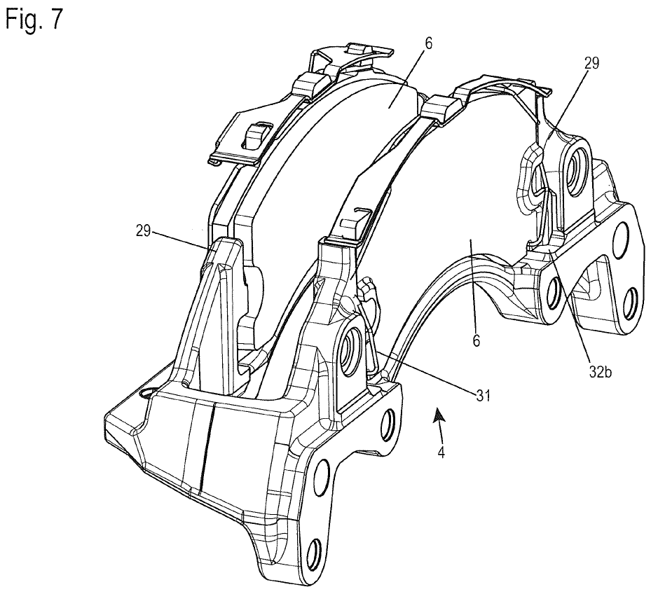

FIGS. 6 and 7 show the brake carrier 4 with brake pads 6 inserted, wherein ears 31 of the brake pad 6 lie in the guide pockets 21 so that the brake pad 6 is guided in the guide pockets. Advantageously, the brake pad carrier is supported at several points by the brake pad horns in the insertion direction of the pad shaft.

In the specific variant shown in FIGS. 6 and 7, it is clearly visible that the brake carrier provides both edge-side support surfaces 28a and 28c as well as support surfaces 32a, 32b at an angle of 80-100°, preferably perpendicular to these support surfaces 28a and 28c at the base of the respective pad carrier horn 29 or at the base of the projection 30. This double support allows a better distribution of force when lateral forces are applied.

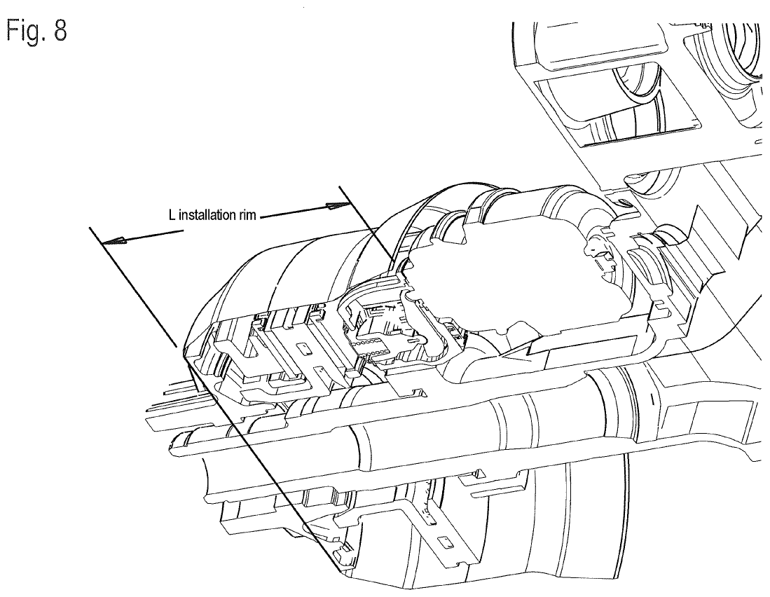

FIG. 8 shows the installation of the disc brake within the rim contour.

### REFERENCE SIGNS

1 disc brake
2 brake disc
3 brake caliper
4 brake carrier
5 pad shafts
6 brake pads
7 mounting space
8 engagement device
9 brake cylinder
10 brake lever
11 eccentric
12 bridge
13 caliper back
14 mounting opening
15 closure plate
16 caliper head
17 support surfaces
18 rolling bearing
19 spherical cap
20 actuating piston
21 guide pockets
22 adjusting spindles
23 installation opening
24 caliper struts
26 pad shaft
27 pad shaft
28a-c support surfaces
29 brake carrier horns
30 projection
50 rolling surface
51 pivot path
201, 202 center points
A rotation axis
U direction of rotation
Z engagement axis

1-10. (canceled)

11. A disc brake for a motor vehicle and/or bus with an electric generator brake, comprising:
a brake disc with an axis of rotation;
a set of brake pads for engaging the brake disc;
a brake caliper configured as a sliding caliper;
an engagement device for actuating the brake pads, the engagement device being arranged in a mounting space of the brake caliper;
an actuating element for introducing an actuating force into the engagement device, wherein
the engagement device comprises a brake lever on which the actuating element acts with the actuating force,
the engagement device acts on the brake pads with an engagement force along an engagement axis, and
a length of the brake lever is selected such that a transmission ratio between the actuating force and the engagement force is between 1:15.60-1:16.45.

12. The disc brake as claimed in claim 11, wherein
the engagement device comprises a bridge that is displaceable via the brake lever, and
a bridge stroke of the bridge is between 2.5-4 mm.

13. The disc brake as claimed in claim 11, wherein
the brake lever has a spherical cap for receiving an actuating piston of the actuating element,
the brake lever has a curved rolling surface along which the brake lever rolls on a rolling bearing in the mounting space of the brake caliper, and
a distance between a center point of the curvature of the spherical cap of the brake lever and a center point of the curvature of the rolling surface of the brake lever is between 78-82 mm.

14. The disc brake as claimed in claim 11, wherein
the engagement device has a roller bearing for pivotably mounting the brake lever,
the brake lever and/or the roller bearing having means for limiting a pivot angle of the brake lever, the means being arranged such that the pivot angle is limited to less than 90°.

15. The disc brake as claimed in claim 14, wherein
the pivot angle is limited to less than 88°.

16. The disc brake as claimed in claim 11, wherein
the brake caliper has a brake pad installation opening which has caliper struts with an axial extension on the edge,
the caliper struts have a radial thickness of greater than 13 mm.

17. The disc brake as claimed in claim 16, wherein the caliper struts have a radial thickness of 14-17 mm.

18. The disc brake as claimed in claim 16, wherein the caliper struts have a radial thickness of 15.5 mm +/−1 mm.

19. The disc brake as claimed in claim 16, wherein
the brake caliper has a caliper back, and
no further element that spans the brake pad installation opening in the axial direction protrudes radially outward from the caliper back.

20. The disc brake as claimed in claim 11, further comprising:
a brake carrier with pad shafts, the pad shafts having guide pockets on an edge for holding and guiding the brake pads.

21. The disc brake as claimed in claim 20, wherein
the guide pockets are formed by projections which protrude into the pad shaft on the edge opposite a pad shaft wall.

22. The disc brake as claimed in claim 11, wherein
the engagement axis Z is arranged at a distance X parallel to the axis of rotation, the distance X being between 2.5-8.5 mm.

23. A method of operating a disc brake in a motor vehicle and/or bus with an electric generator brake, comprising using a disc brake according to claim 11, and performing cooperative braking with the electric generator brake simultaneously with the disc brake.

24. A method for engaging a disc brake for a motor vehicle and/or bus with an electric generator brake, wherein the disc brake includes:
a brake disc with an axis of rotation;
a set of brake pads for engaging the brake disc;
a brake caliper configured as a sliding caliper;
an engagement device for actuating the brake pads, the engagement device being arranged in a mounting space of the brake caliper;
an actuating element for introducing an actuating force into the engagement device, wherein
the engagement device comprises a brake lever on which the actuating element acts with the actuating force,
the engagement device acts on the brake pads with an engagement force along an engagement axis, and
a length of the brake lever is selected such that a transmission ratio between the actuating force and the engagement force is between 1:15.60-1:16.45,
wherein the method comprises:
pivoting the brake lever at a pivot angle of less than 90° during the engagement process over an entire service life of the disc brake.
